(19) United States
(12) Patent Application Publication
(10) Pub. No.: US 2008/0028526 A1
(43) Pub. Date: Feb. 7, 2008

(54) Bed device and MRI apparatus

(75) Inventor: Yutaka Kato, Nasushiobara-shi (JP)

Correspondence Address: NIXON & VANDERHYE, PC, 901 NORTH GLEBE ROAD, 11TH FLOOR, ARLINGTON, VA, 22203, US

(73) Assignees: KABUSHIKI KAISHA TOSHIBA, Tokyo (JP); TOSHIBA MEDICAL SYSTEMS CORPORATION, Tochigi (JP)

(21) Appl. No.: 11/902,697

(22) Filed: Sep. 25, 2007

Related U.S. Application Data
(63) Continuation of application No. PCT/JP2006/306717, filed on Mar. 30, 2006.

(30) Foreign Application Priority Data
Mar. 30, 2005 (JP) 2005-099293

(51) Int. Cl. A61G 7/00; A61G 7/018

(52) U.S. Cl. 5/601; 5/943

(57) ABSTRACT

Provided are a bed device and an MRI apparatus which can easily move a top board by one mechanism. The bed device and the MRI apparatus include a top board on which an object is disposed, a middle frame that is disposed on the lower side of the top board and supports the top board, a bed supporting part that is disposed on the lower side of the middle frame and supports the middle frame, and a horizontal movement mechanism that horizontally move the top board and the middle frame. Furthermore, the horizontal movement mechanism moves the top board and the middle frame in a longitudinal direction and moves the only top board in a width direction.

### CROSS-REFERENCE TO RELATED APPLICATIONS

This is a Continuation Application of PCT Application No. PCT/JP2006/306717, filed Mar. 30, 2006, which was published under PCT Article 21(2) in Japanese.

This application is based upon and claims the benefit of priority from prior Japanese Patent Application No. 2005-099293, filed Mar. 30, 2005, the entire contents of which are incorporated herein by reference.

### BACKGROUND OF THE INVENTION

1. Field of the Invention

The present invention relates to a bed device and an MRI apparatus which are used in an image diagnostic apparatus.

2. Description of the Related Art

In general, an MRI (Magnetic Resonance Imaging) apparatus, an X-ray CT (Computed Tomography) apparatus, a PET (Position Emission Tomography) apparatus or the like have been used as an image diagnostic apparatus which images an object and conducts an image diagnostic.

The image diagnostic apparatus, such as the MRI apparatus, X-ray CT apparatus, and PET apparatus includes a pedestal provided with an opening for imaging the object. The object is inserted into the opening and imaged. Further, the X-ray image diagnostic apparatus for a circulatory organ includes an imaging unit that is provided with an X-ray generator and an X-ray detector facing a C-shaped end portion, and the object is inserted between (into an opening) the X-ray generator and the X-ray detector so as to be imaged.

In addition, the insertion of the object into the image diagnostic apparatus is performed by mounting the object on a top board of the bed device, which is disposed in a vicinity of the opening of the pedestal, and moving the object on the top board into the opening of the image diagnostic apparatus.

However, in the case of imaging by using the MRI apparatus, there has been proposed a bed device which moves the object on the top board in a width direction, after moving the object into the opening (for example, see JP-A-2001-252260). In addition, when a high frequency magnetic field is radiated to the object in order to excite hydrogen nuclei inside of the object and a RF coil for receiving nuclear magnetic resonance signals emitted from the object is used to image the object, the operator of the apparatus moves the object so as to align the object with the RF coil even though the object mounted on the top board and RF coil is moved.

In addition, there has been a bed device that is provided with an upper and a lower top boards for imaging the entire body of the object or the wide region closer to the entire body. Even though the object is mounted on the upper top board of the bed device and the upper and lower top boards are aligned and horizontally moved in the longitudinal direction so as to set the object to an imaging position, when the object is not set to a predetermined position, the upper top board is manually pushed to be set. In addition, in the case of conducting the imaging by using the RF coil, the operator moves the RF coil which is mounted on the top board so as to align the RF coil with the object.

However, in the case of the bed device capable of moving the top board in the width direction, a big and heavy unit, which includes a frame disposed in the pedestal and an inlet of the opening of the pedestal and a rail for moving the top board connected to the frame, is also driven with a good balance and moved. For this reason, there have been problems in that a driving system has a large load, a slide guide having a high precision is required, and the apparatus has a complicated configuration due to the requirement of two kinds of mechanisms to be moved in the longitudinal and width directions.

In addition, in the case of the bed device extending the upper and lower top boards, since the upper top board is manually moved, it has troubles of efforts to make. Like the lower top board, if the upper top board includes a driving mechanism, cable or the like, two mechanisms for the upper and lower are required in two places. Accordingly, there has been a problem in that the apparatus has a complicated configuration.

Furthermore, when the RF coil is used to image an object, since the operator needs to move the object or the RF coil having weight so as to align the object or the RF coil with each other, there has a problem in that the effort and labor are required.

### BRIEF SUMMARY OF THE INVENTION

It is an object of the invention to provide a bed device and an MRI apparatus that can easily move a top board by one mechanism.

In order to achieve the above-mentioned object, a bed device of the invention according to claim 1 includes a top board on which an object is disposed, a middle frame that is disposed on the lower side of the top board and supports the top board, a bed supporting part that is disposed on the lower side of the middle frame and supports the middle frame, and movement mechanisms that move both the top board and the middle frame in a longitudinal direction and separately move the top board from the middle frame in a width direction.

A bed device of the invention according to claim 10 include a top board on which an object is disposed, a middle frame that is disposed on the lower side of the top board, a bed supporting part that supports the top board and the middle frame, a first driving mechanism that supplies a driving force for moving the top board and the middle frame, a second driving mechanism that supplies a driving force for moving the top board and the middle frame, and movement mechanisms that transmit driving forces having a same magnitude and a same direction from the first and second driving mechanisms so as to move the top board and the middle frame in a longitudinal direction and transmit driving forces having a same magnitude and a direction different from each other from the first and second driving mechanisms so as to move the only top board in a longitudinal direction.

A bed device of the invention according to claim 15 includes a top board on which an object is disposed, a middle frame that is disposed on the lower side of the top board and supports the top board, a bed supporting part that is disposed on the lower side of the middle frame and supports the middle frame, driving mechanisms that are provided in the bed supporting part and generate driving forces for moving the top board and the middle frame, and transmittance mechanisms that transmit the driving forces from the driving mechanisms to the top board and the middle frame.

An MRI apparatus of the invention according to claim 16 includes a bed device including a top board on which an object is disposed, a middle frame that is disposed on the lower side of the top board and supports the top board, a bed supporting part that is disposed on the lower side of the middle frame and supports the middle frame, and a driving mechanism that moves the top board and the middle frame together in a longitudinal direction and moves the top board in a width direction separately from the middle frame, and an MRI apparatus main body that conducts an MRI imaging by generating a magnetic field with respect to the object.

### BRIEF DESCRIPTION OF THE SEVERAL VIEWS OF THE DRAWING

FIG. 1 is a block diagram showing a structure of a bed device according to a first embodiment of the invention.

FIG. 2A is a plain view showing a structure of a bed according to a first embodiment of the invention.

FIG. 2B is a side view showing a structure of a bed according to a first embodiment of the invention.

FIG. 3A is a plain view showing a structure of a horizontal movement mechanism according to a first embodiment of the invention.

FIG. 3B is a side view showing a structure of a horizontal movement mechanism according to a first embodiment of the invention.

FIG. 4 is a side view showing a structure of a vertical movement mechanism according to a first embodiment of the invention.

FIG. 5A is a plain view showing an operation of a main body of a bed according to a first embodiment of the invention.

FIG. 5B is a side view showing an operation of a main body of a bed according to a first embodiment of the invention.

FIG. 6A is an explanatory view showing an operation of a horizontal movement mechanism for moving a main body of a bed according to a first embodiment of the invention.

FIG. 6B is an explanatory view showing an operation of a horizontal movement mechanism for moving a main body of a bed according to a first embodiment of the invention.

FIG. 7A is a plain view showing an operation of a top board according to a first embodiment of the invention.

FIG. 7B is a side view showing an operation of a top board according to a first embodiment of the invention.

FIG. 8A is an explanatory view showing an operation of a horizontal movement mechanism for moving a top board according to a first embodiment of the invention.

FIG. 8B is an explanatory view showing an operation of a horizontal movement mechanism for moving a top board according to a first embodiment of the invention.

FIG. 9A is a plain view showing an operation of a top board and a middle frame according to a first embodiment of the invention.

FIG. 9B is a side view showing an operation of a top board and a middle frame according to a first embodiment of the invention.

FIG. 10A is an explanatory view showing an operation of a horizontal movement mechanism for moving a top board and a middle frame according to a first embodiment of the invention.

FIG. 10B is an explanatory view showing an operation of a horizontal movement mechanism for moving a top board and a middle frame according to a first embodiment of the invention.

FIG. 11A is an explanatory view showing an operation of a horizontal movement mechanism for moving a middle frame and a top board according to a first embodiment of the invention.

FIG. 11B is an explanatory view showing an operation of a horizontal movement mechanism for moving a middle frame and a top board according to a first embodiment of the invention.

FIG. 12 is a block diagram showing a structure of a bed device according to a second embodiment of the invention.

FIG. 13A is a plain view showing a structure of a main body of a bed according to a second embodiment of the invention.

FIG. 13B is a side view showing a structure of a main body of a bed body according to a second embodiment of the invention.

FIG. 14A is a plain view showing a structure of a horizontal movement mechanism according to a second embodiment of the invention.

FIG. 14B is a side view showing a structure of a horizontal movement mechanism according to a second embodiment of the invention.

FIG. 15A is a plain view showing an operation of a main body of a bed according to a second embodiment of the invention.

FIG. 15B is a side view showing an operation of a main body of a bed according to a second embodiment of the invention.

FIG. 16A is an explanatory view showing an operation of a horizontal movement mechanism for moving a main body of a bed according to a second embodiment of the invention.

FIG. 16B is an explanatory view showing an operation of a horizontal movement mechanism for moving a main body of a bed according to a second embodiment of the invention.

FIG. 17A is a plain view showing an operation of a top board according to a second embodiment of the invention.

FIG. 17B is a side view showing an operation of a top board according to a second embodiment of the invention.

FIG. 18A is an explanatory view showing an operation of a horizontal movement mechanism for moving a top board according to a second embodiment of the invention.

FIG. 18B is an explanatory view showing an operation of a horizontal movement mechanism for moving a top board according to a second embodiment of the invention.

### BEST MODE FOR CARRYING OUT THE INVENTION

The invention relates to an image diagnostic apparatus provided with a frame having an imaging mechanism for forming images, such as an X-ray CT apparatus, an MRI apparatus, a PET apparatus, an X-ray image diagnostic apparatus or the like, but the case that the invention is used in the MRI apparatus will be described, hereinafter.

### Example 1

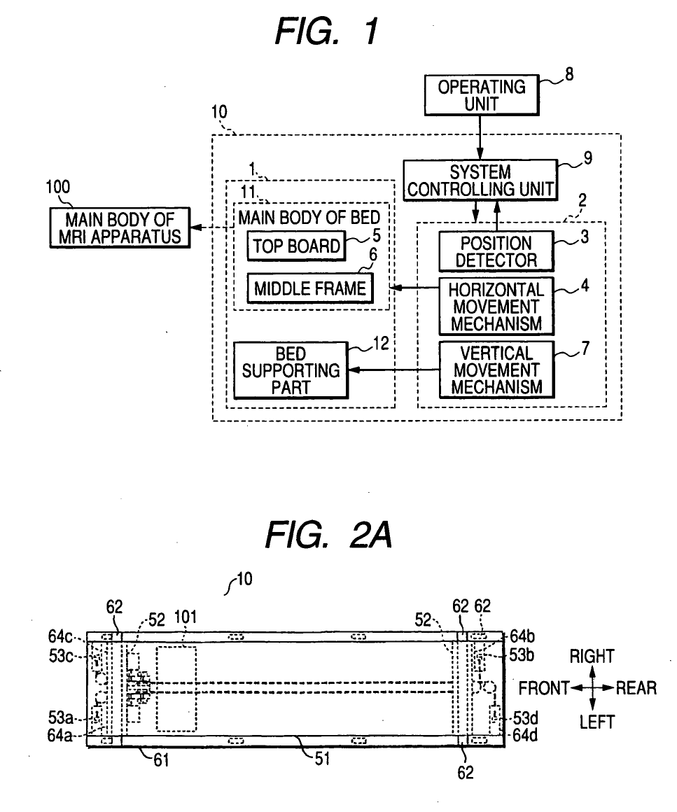

Hereinafter, a bed device according to a first embodiment of the invention will be described with reference to FIGS. 1 to 11.

FIG. 1 is a block diagram showing the structure of a bed device according to a first embodiment of the invention. The bed device 10 includes a bed 1 on which an object is disposed, a mechanism 2 for moving the bed 1 in a horizontal direction and a vertical direction, an operating unit 8 for setting and inputting the position of the bed 1, and a system controlling unit 9 for controlling the mechanism 2.

The bed 1 includes a main body 11 of a bed for moving in a horizontal direction and a bed supporting part 12 for supporting the main body 11 of the bed. The main body 11 of the bed includes a top board 5 on which the object is mounted, and a middle frame 6 for supporting the top board 5.

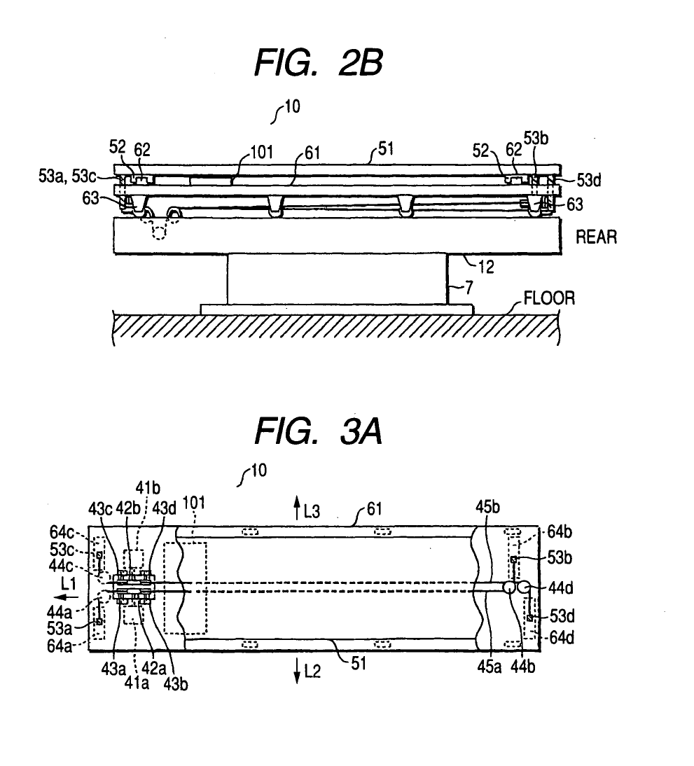

FIG. 2 is a view showing a structure of the main body 11 of the bed, the top board 5, and the middle frame 6 of the bed device 10. FIG. 2A is a top view of the bed device 10, and FIG. 2B is a side view of the bed device 10. Hereinafter, a left side and right side of the bed device 10 shown in FIGS. 2A and 2B are referred to as a front and rear sides, respectively. Furthermore, an upper side and lower side shown in FIG. 2A are referred to as a right and left sides, respectively.

The top board 5 is provided with a rectangular top board body 51 on which the object is mounted, front and rear slide guides 52 that move the main body 51 of the top board in the width direction, and four top board fixing parts 53 (53a to 53d) that transmit a driving force for moving the top board 5 from front to rear and from side to side into the main body 51 of the top board.

The object is mounted on the upper surface of the main body 51 of the top board, and two slide guides 52 are disposed at front and rear ends of the lower surface thereof so as to be spaced apart from each other and parallel with each other. The top board 5 may be smoothly moved on the middle frame 6 in the width direction due to the slide guides 52.

The top board fixing part 53 is composed of rectangular-column shaped four top board fixing parts 53a to 53d that are vertically disposed on the lower surface of the main body 51 of the top board. In addition, the top board fixing part 53a is disposed on the left side of the center in the width direction in the vicinity of the front end of the main body 51 of the top board, and the top board fixing part 53c is disposed so as to be symmetrical to the top board fixing part 53a with respect to the center line of the main body 51 of the top board in the width direction. Furthermore, the top board fixing part 53b is disposed on the rear side of the top board fixing part 53c in the vicinity of the rear end of the main body 51 of the top board, and the top board fixing part 53d is disposed on the rear side of the top board fixing part 53b on the rear side of the top board fixing part 53a of the main body 51 of the top board.

The middle frame 6 of the main body 11 of the bed is disposed between the main body 51 of the top board and the bed supporting part 12 and is composed of a main body 61 of the middle frame, a rail 62 for supporting the main body 51 of the top board, a roller 63, and four slotted holes 64 (64a to 64d).

The main body 61 of the middle frame is formed in a rectangular shape having a short side that is longer than the short side of the main body 51 of the top board and a long side that is approximately equal to the length of the long side of the main body 51 of the top board.

The rail 62 is disposed on the upper surface of the main body 61 of the middle frame and engaged with the slide guide 52 of the main body 51 of the top board. In addition, the rail 62 supports the main body 51 of the top board so as to allows the main body 51 of the top board to horizontally move in the width direction, and prevents the main body 51 of the top board from horizontally moving on the middle frame 6 in a longitudinal direction of the main body 51 of the top board.

The plurality of rollers 63 is disposed at regular intervals over both ends of the long side on the lower surface of the main body 61 of the middle frame. The main body 61 of the middle frame may be smoothly moved on the bed supporting part 12 in the longitudinal direction by the rollers 63.

The slotted hole 64 is composed of the slotted holes 64a to 64d that are formed in the main body 61 of the middle frame in the width direction thereof, and the top board fixing parts 53a to 53d of the top board 5 are penetrated so as to correspond to the slotted holes 64a to 64d.

Furthermore, when a main body 100 of the MRI apparatus is used to conduct an MRI imaging of the object, a RF coil 101 that radiates a high frequency magnetic field in order to excite hydrogen nuclei inside of the object and receives nuclear magnetic resonance signals emitted from the object is disposed at any position on the middle frame 6.

The main body 100 of the MRI apparatus includes a gantry into which the object is inserted, and the gantry includes a static field magnet, a gradient magnetic field coil, a gradient magnetic field power supply and the like. The static field magnet has a hollow cylindrical shape and generates a uniform static magnetic field at the inner space thereof. As the static field magnet, for example, a permanent magnet, a superconductive magnet or the like is used. The gradient magnetic field coil has a hollow cylindrical shape and is disposed inside the static field magnet. The gradient magnetic field coil is configured such that three kinds of coils corresponding to respective three axes perpendicular to each other are combined. The gradient magnetic field coil is configured such that the three kinds of coils separately receive a current supplied from the gradient magnetic field power supply, thus generating a gradient magnetic field of which magnetic field intensity inclines along each of the three axes.

The bed supporting part 12 is disposed on the lower side of the middle frame 6 and forms a rectangular upper surface that is approximately similar to the shape of the middle frame 6. In addition, the bed supporting part 12 supports the middle frame 6 so that the middle frame 6 horizontally is movable in the longitudinal direction, and prevents the middle frame 6 from horizontally moving in the width direction.

The mechanism 2 of FIG. 1 is provided with a horizontal movement mechanism 4 that horizontally moves the bed body 11 of the bed 1, a position detector 3 that detects the position of the main body 11 of the bed from the operation the horizontal movement mechanism 4, and a vertical movement mechanism 7 that vertically moves the bed supporting part 12 of the bed 1.

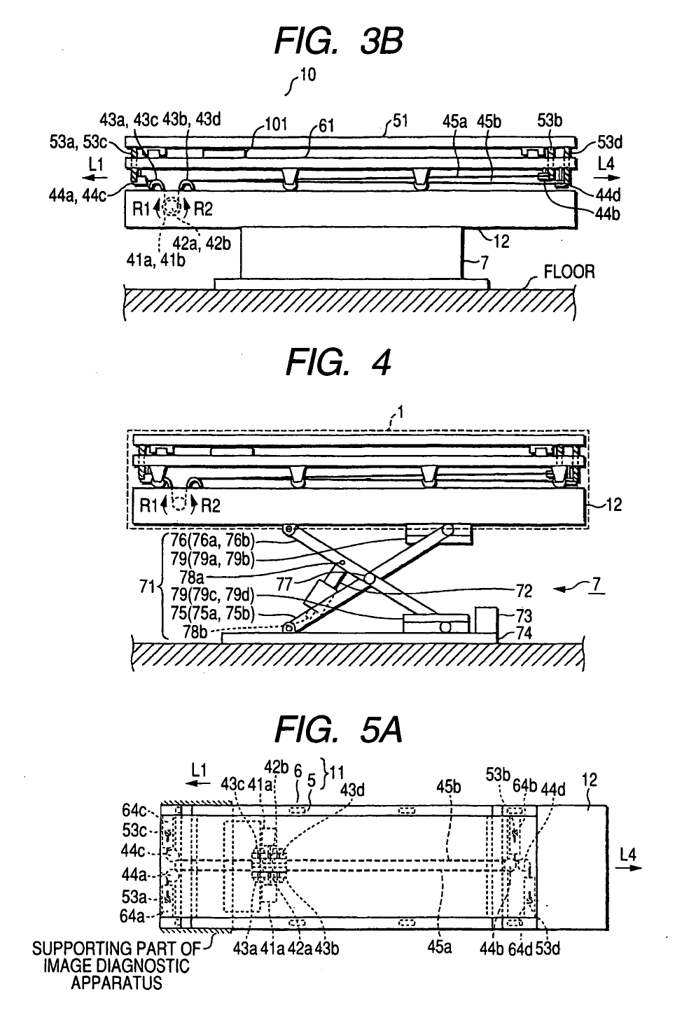

FIGS. 3A and 3B are views showing structures of a horizontal movement mechanism 4. FIG. 3A is a configuration view of the horizontal movement mechanism 4 as viewed from the upper side by cutting the front and rear sides of the bed device 10, and FIG. 3B is a left side view of the horizontal movement mechanism 4.

The horizontal movement mechanism 4 includes two motors 41 (41a and 41b) as a power source for driving the main body 11 of the bed, two driving pulleys 42 (42a and 42b) that transmit a driving force of the motor 41 to two wires 45 (45a and 45b), four idle pulleys 43 (43a to 43d) that convert the directions of the two wires 45, and four guide pulleys 44 (44a to 44d) that transmit the driving force from the two wires 45 to the middle frame 6. The driving force from the two wires 45 is also transmitted to the main body 51 of the top board through the four top board fixing parts 53a to 53d.

The motor 41 is composed of the motors 41a and 41b provided in the vicinity of the front end inside the bed supporting part 12. The rotation shafts of the motors 41a and 41b face each other to be line symmetric with respect to a centerline of the bed supporting part 12 in the width direction, and the motors 41a and 41b are disposed and fixed so as to be parallel to the short side of the bed supporting part 12. Furthermore, the rotation number, the rotation speed or the like of the motors 41a and 41b is controlled by the system controlling unit 9.

The driving pulley 42 is a toothed wheel that is engaged with the wires 45a and 45b. In addition, the driving pulley 42 is composed of the driving pulleys 42a and 42b that have tooth of the same number and are fixed to the rotation shafts of the motors 41a and 41b.

The idle pulleys 43 are provided so as to transmit the driving force from the driving pulleys 42a and 42b to the guide pulleys 44a to 44d and the top board fixing parts 53a to 53d. The idled pulley 43 is composed of the idle pulleys 43a and 43b disposed at the front and rear of the upper side of the driving pulley 42a and the idle pulleys 43c and 43d disposed at the front and rear of the upper side of the driving pulley 42b. Furthermore, the rotation shafts of the idle pulleys 43a to 43d are disposed so as to be parallel and horizontal to the short side of the bed supporting part 12, and one end of each rotation shaft is fixed to upper side of the upper surface of the bed supporting part 12.

The guide pulley 44 is composed of the guide pulleys 44a to 44e in which the end of each rotation shaft is vertically fixed to the lower surface of the main body 61 of the middle frame. Among the guide pulleys 44a to 44d, the guide pulleys 44a and 44c, as shown in FIG. 3A, are disposed between the center and the slotted hole 64a and between the center and the slotted hole 64c in the width direction of the main body 61 of the middle frame in the vicinity of the front end of the main body 61 of the middle frame.

In addition, the guide pulleys 44b and 44d are disposed on the right side of the slotted hole 64b and the left side of the slotted hole 64d in the vicinity of the rear end of the main body 61 of the middle frame, and in the vicinity of the center in the width direction of the main body 61 of the middle frame. Further, the guide pulley 44b is disposed on the upper side of the guide pulley 44d so that the wires 45 wound around the guide pulley 44 do not interfere with each other.

The wire 45 is composed of the wires 45a and 45b that engage with the driving pulleys 42a and 42b. The one end of the wire 45a is supported by the lower end of the top board fixing part 53a and winds around the guide pulley 44a, the idle pulley 43a, the driving pulley 42a, the idle pulley 43b, and the guide pulley 44b so that the other end thereof is held by the lower end of the top board fixing part 53b.

In addition, the wire 45b is held by the lower end of the top board fixing part 53c and winds around the guide pulley 44c, the idle pulley 43c, the driving pulley 42b, the idle pulley 43d, and the guide pulley 44d so that the other end thereof is held to the lower end of the top board fixing part 53d.

For this reason, the wires 45a and 45b, as shown in FIG. 3A, are interchanged between the guide pulley 44b and the top board fixing part 53b and between the guide pulley 44c and the guide pulley 44d.

The position detector 3 is provided at the driving pulleys 42a and 42b, and outputs the rotation number of the driving pulleys 42a and 42b detected by using, for example, an encoder to the system controlling unit 9. The system controlling unit 9 controls the motors 41a and 41b of the horizontal movement mechanism 4 on the basis of the output signals from the position detector 3, thus setting the position of the top board 5 and the middle frame 6.

The horizontal movement mechanism 4 configured as described above may horizontally move the main body 11 of the bed in the longitudinal direction. In addition, the horizontal movement mechanism 4 may horizontally move the main body 51 of the top board in the width direction at any position where the main body 11 of the bed is moved. Furthermore, the horizontal movement mechanism 4 may horizontally move the main body 11 of the bed in the longitudinal direction and may horizontally move the main body 51 of the top board in the width direction.

FIG. 4 is a view showing a structure of a vertical movement mechanism 7 as viewed from the left side of the bed device 10. The vertical movement mechanism 7 is disposed between the bed supporting part 12 and a floor of the bed 1, and includes a linkage 71 that vertically moves the bed 1, a hydraulic unit 73 that drives the linkage 71 through a hydraulic cylinder 72, and a rectangular link base 74 that supports the linkage 71 and the hydraulic unit 73.

The linkage 71 is composed of four arms 75 (75a and 76b) and 76 (76a and 76b), a rotation shafts 77 of the arms 75 and 76, two supporting shafts 78 (78a and 78b) that support the hydraulic cylinder 72, and four guides 79 (79a to 79d) that held the ends of the arms 75 and 76.

The arm 75 is composed of the arms 75a and 75b having the same length. The arm 75 is configured such that one end thereof is rotatably held by both ends in the width direction of the linkage 74, and the other end thereof is slidably held by the guides 79a and 79b of the guide 79 in the horizontal direction, the guides 79a and 79b being provided at both ends of the lower surface of the bed supporting part 12 in the width direction.

The arm 76 has the same length as the arms 75a and 75b and is composed of arms 76a and 76b that intersect in the center thereof. For this reason, one ends of the arms 76a and 76b are located on the upper side of the one ends of the arms 75a and 75b and rotatably held by the lower surface of the bed supporting part 12. In addition, the other ends of the arms 76a and 76b are located on the lower side of the other ends of the arms 75a and 75b and are slidably held by the guides 79c and 79d of the guide 79, which are provided on the link base 74, in the horizontal direction.

The rotation shaft 77 is held such that one end thereof is loosely fitted in a hole that is formed at an intersecting portion of the arms 75a and 76a and the other end thereof is loosely fitted in a hole that is formed at an intersecting portion of the arms 76a and 76b.

The supporting shaft 78 is composed of the supporting shafts 78a and 78b that are horizontally disposed. One end of the supporting shaft 78a is fixed to the upper side of the portion that intersects with the arm 75a of the arm 76a and the other end of the supporting shaft 78a is fixed to the upper of the portion that intersects with the arm 75b of the arm 76b.

In addition, in the supporting shaft 78b of the supporting shaft 78, one end of the supporting shaft 78b is fixed to the lower side of the portion that intersects with the arm 76a of the arm 75a and the other end of the supporting shaft 78b is fixed to the lower side of the portion that intersects with the arm 76b of the arm 75b.

The hydraulic cylinder 72 is configured such that one end and the other end thereof are elastically held by the center of the supporting shafts 78a and 78b of the linkage 71.

The hydraulic unit 73 includes a hydraulic pump that conveys the hydraulic pressure to the hydraulic cylinder 72, a switching valve (not shown) and the like. In addition, the hydraulic unit 73 adjusts the length of the hydraulic cylinder 72.

The vertical movement mechanism 7 configured as described above expands and contracts the hydraulic cylinder 72 into and from the hydraulic unit 73 through the control of the system controlling unit 9 to drive the supporting shafts 78a and 78b of the linkage 71 and moves the bed 1 in the vertical direction so that the respective one ends of the arms 75 and 76 rotate around the rotation shaft 77 by the driving force and the other end allows the guide 79 to slide.

The operating unit 8 of FIG. 1 includes an input device (not shown), such as a keyboard, a display panel or the like, and conducts the input or the like for setting the bed 1 to a predetermined position. The operating unit 8 is disposed in the vicinity of the gantry of the bed device 10 or the MRI apparatus 100.

The system controlling unit 4 includes, for example, CPU or a storage circuit not shown in drawings and performs the control of the entire system, such as a control of the movement of the mechanism 2 on the basis of the input signals from the operating unit 8.

Next, the operation of the main body 11 of the bed and the horizontal movement mechanism 4 that horizontally moves the main body 11 of the bed will be described.

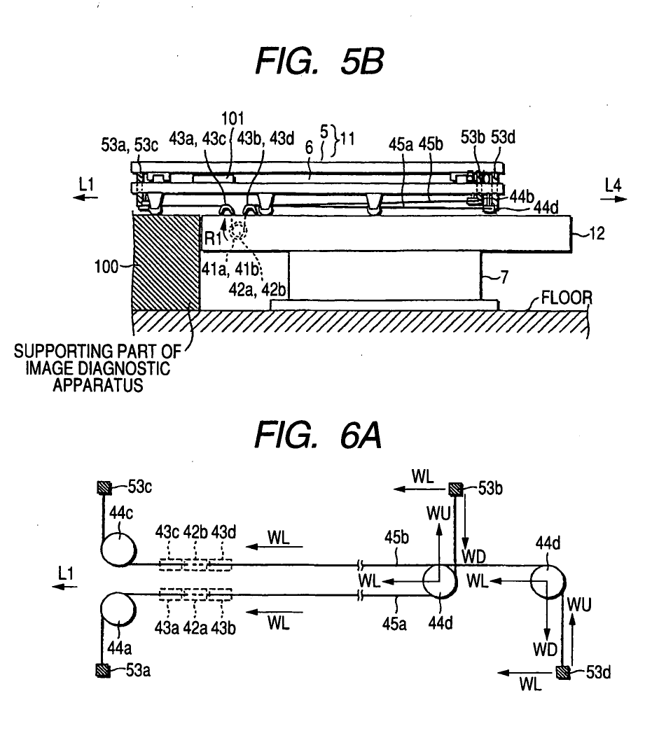

FIGS. 5A and 5B are views showing an operation for moving a main body 11 of the bed in the forward and backward direction. The operating unit 8 sets the position of the main body 11 of the bed, and the system controlling unit 9 controls the horizontal movement mechanism 4 and sets so that the main body 11 of the bed horizontally moves on a supporting part of the image diagnostic apparatus of the MRI apparatus 100 and the bed supporting part 12 in the direction of an arrow L1 or L4. In addition, until the guide pulley 44b of the horizontal movement mechanism 4 arrives in the vicinity of the idle pulley 43d, the main body 11 of the bed may be moved in the L1 direction.

By the control of the system controlling unit 9, the horizontal movement mechanism 4 horizontally moves the main body 11 of the bed from a home position shown in FIG. 3 in the L1 direction by rotating both the motors 41a and 41b at the same speed in the direction of the arrow R1. Accordingly, for example, the horizontal movement mechanism 4 may set the main body 11 of the bed at a predetermined position on the supporting part of the image diagnostic apparatus shown in FIG. 5. In addition, the horizontal movement mechanism 4 horizontally moves the main body 11 of the bed into the L4 direction by rotating both the motors 41a and 41b at the same speed in the direction of the arrow R2, thus setting the main body 11 of the bed at an original home position.

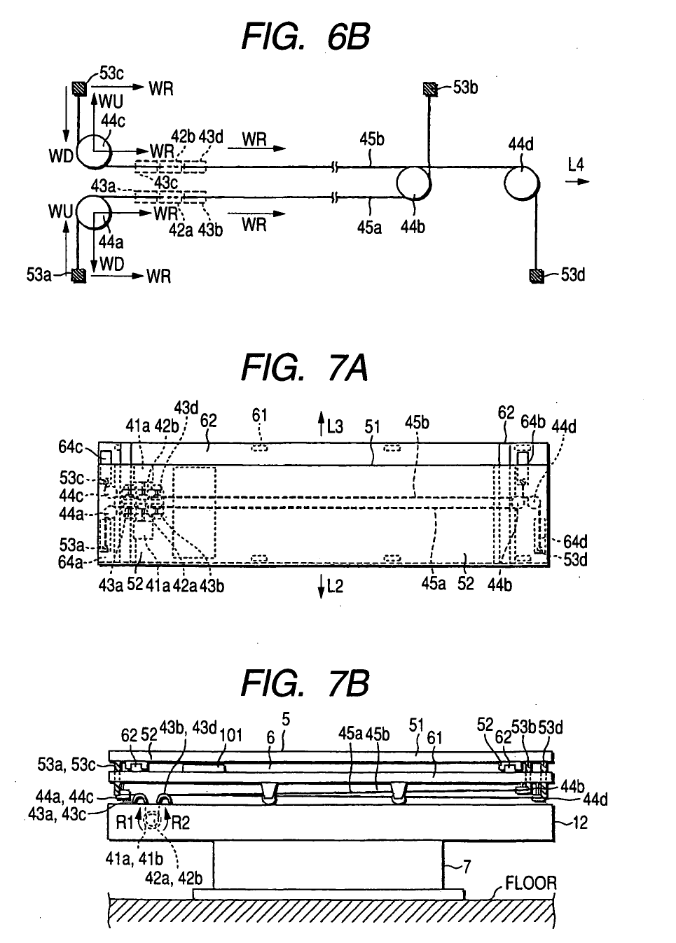

FIG. 6A is a view showing the magnitude and direction of the driving force of the horizontal movement mechanism 4 in moving the main body 11 of the bed into the L1 direction. By rotating both the motors 41a and 41b at the same speed in the direction of the R1, the tension WL indicated as arrows acts on the wire 45a between the idle pulley 43b and the guide pulley 44b through the driving pulley 42a and on the wire 45b between the idle pulley 43d and the guide pulley 44d through the driving pulley 42b.

Due to the tension WL acting on the wire 45a, a driving force WL and a driving force WU that is oriented to the top board fixing part 53b and has the same magnitude as the driving force WL act on the guide pulley 44b, and the driving force WL and a driving force WD that is reversely oriented and has the same magnitude as the driving force WU act on the guide pulley 44b act on the top board fixing part 53b. In addition, due to the tension WL acting on the wire 45b, the driving forces WL and WD act on the guide pulley 44d, and the driving forces WL and WU act on the top board fixing part 53d.

For this reason, since the driving forces acting on the left and right directions of the middle frame 6 that supports the guide pulleys 44b and 44d are WU and WD, the middle frame 6 is balanced. Meanwhile, since the driving forces acting on the left and right direction of the top board 5 that supports the top board fixing parts 53b and 53d are WU and WD, the top board 5 is balanced. Therefore, the top board 5 does not move in the left and right directions.

Accordingly, since the total driving force acting on the guide pulleys 44b and 44d is 2 WL relative to the L1 direction, the middle frame 6 moves onto the bed supporting part 12 in the L1 direction by the driving force of 2 WL. Meanwhile, since the total driving force acting on the top board fixing parts 53b and 53d is 2 WL relative to the L1 direction, the driving force of 2 WL also acts on the top board 5 as well as the middle frame 6 in the L1 direction. Accordingly, the top board 5 moves together with the middle frame 6 in the L1 direction.

FIG. 6B is a view showing the magnitude and direction of the driving force of the horizontal movement mechanism 4 in moving the main body 11 of the bed into the L4 direction. By rotating both the motors 41a and 41b at the same speed in the direction of the R2, the tension WR indicated as arrows acts on the wire 45a between the idle pulley 43a and the guide pulley 44a through the driving pulley 42a and on the wire 45b between the idle pulley 43c and the guide pulley 44c through the driving pulley 42b.

Due to the tension WR acting on the wire 45a, the driving forces WR and WD act on the guide pulley 44a, and the driving forces WD and WU act on the top board fixing part 53a. In addition, due to the tension WL acting on the wire 45b, the driving forces WR and WU act on the guide pulley 44c, and the driving forces WR and WD act on the top board fixing part 53c.

For this reason, since the driving forces acting on the left and right directions of the middle frame 6 that holds the guide pulleys 44a and 44c are WU and WD, the middle frame 6 is balanced. Meanwhile, since the driving forces acting on the left and right direction of the top board 5 that holds the top board fixing parts 53a and 53c are WU and WD, the top board 5 is balanced. Therefore, the top board 5 does not move in the left and right directions.

Accordingly, since the total driving force acting on the guide pulleys 44a and 44c is 2 WR relative to the L4 direction, the middle frame 6 moves the bed supporting part 12 in the L4 direction by the driving force of 2 WR. Meanwhile, since the total driving force acting on the top board fixing parts 53a and 53c is 2 WR relative to the L4 direction, the driving force of 2 WL also acts on the top board 5 as well as the middle frame 6 in the L4 direction. Accordingly, the top board 5 moves together with the middle frame 6 in the L4 direction.

FIG. 7 is a view showing a moving operation of a top board 5 in the left and right directions. The operating unit 8 sets the top board, and the system controlling unit 9 controls the horizontal movement mechanism 4 and set so as to horizontally move the top board 5 into the direction of an arrow L2 or L3. In addition, the top board 5 is moved in the L2 direction until the top board fixing parts 53c and 53d of the top board 5 are located in the vicinity of the end inside the slotted holes 64c and 64d of the middle frame 6, and the top board 5 is moved in the L3 direction until the top board fixing parts 53a and 53b of the top board 5 arrive in the vicinity of the end inside the slotted holes 64a and 64b of the middle frame 6.

By the control of the system controlling unit 9, the horizontal movement mechanism 4 horizontally moves the top board 5 from the home position shown in FIG. 3 in the L2 direction by simultaneously rotating the motors 41a and 41b at the same speed in the direction of the R1 and R2, respectively. Accordingly, for example, the horizontal movement mechanism 4 may set the top board 5 to the position shown in FIGS. 7A and 7B. In addition, the horizontal movement mechanism 4 horizontally moves the top board 5 in the L3 direction by simultaneously rotating the motors 41a and 41b at the same speed in the direction of the R2 and R1, respectively, thus setting the top board 5.

In addition, the top board 5 may be moved in the direction of L2 and L3 at not only the home position but also any position where the main body of the bed has moved in the direction of L1.

Furthermore, in the case of imaging the object by using the main body 100 of the MRI apparatus, the top board 5 on which the object is mounted moves in the direction of L2 or L3, resulting in being aligned with the RF coil 101 disposed on the middle frame 6.

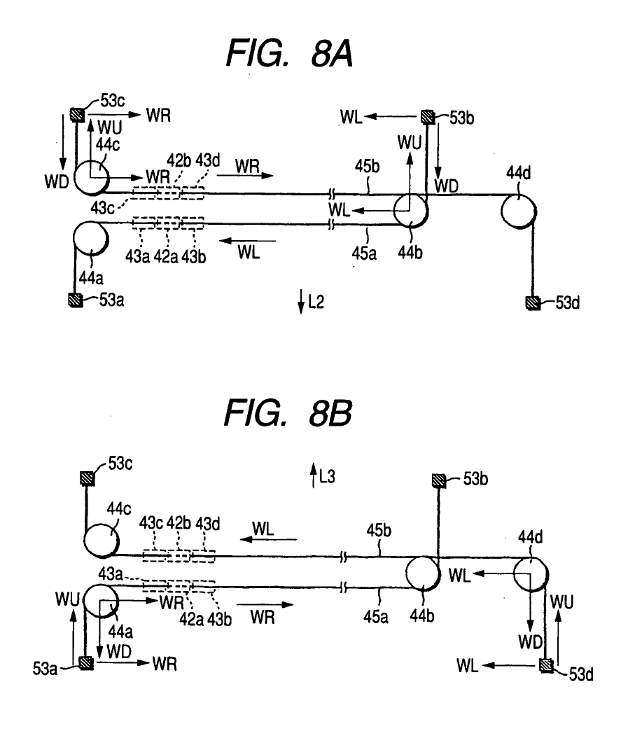

FIG. 8A is a view showing the magnitude and direction of the driving force of the horizontal movement mechanism 4 in moving the top board 5 into the L2 direction. By simultaneously rotating the motors 41a and 41b at the same speed in the direction of the R1 and R2, respectively, the tension WL indicated as an arrow acts on the wire 45a between the idle pulley 43b and the guide pulley 44b through the driving pulley 42a and the tension WR indicated as an arrows acts on the wire 45b between the idle pulley 43c and the guide pulley 44c through the driving pulley 42b.

Due to the tension WL acting on the wire 45a, the driving forces WL and WU act on the guide pulley 44b, and the driving forces WL and WD act on the top board fixing part 53b. In addition, due to the tension WR acting on the wire 45b, the driving forces WR and WU act on the guide pulley 44c, and the driving forces WR and WD act on the top board fixing part 53c.

Accordingly, since the total driving force acting on the guide pulleys 44b and 44c is 2 WU relative to the L3 direction, the driving force of 2 WU acts on the middle frame 6, but the middle frame 6 does not move because the driving force is blocked in the width direction. Meanwhile, since the total driving force acting on the top board fixing parts 53b and 53c is 2 WD relative to the L2 direction, the top board 5 moves on the middle frame 6 by the driving force of 2 WD in the L2 direction.

FIG. 8B is a view showing the magnitude and direction of the driving force of the horizontal movement mechanism 4 in moving the top board 5 into the L3 direction. By simultaneously rotating the motors 41a and 41b at the same speed in the direction of the R1 and R2, respectively, the tension WR as an arrow act on the wire 45a between the idle pulley 43a and the guide pulley 44a through the driving pulley 42a and the tension WL indicated as an arrow act on the wire 45b between the idle pulley 43d and the guide pulley 44d through the driving pulley 42b.

Due to the tension WR acting on the wire 45a, the driving forces WR and WD act on the guide pulley 44a, and the driving forces WR and WU act on the top board fixing part 53a. In addition, due to the tension WL acting on the wire 45b, the driving forces WL and WD act on the guide pulley 44d, and the driving forces WL and WU act on the top board fixing part 53d.

Accordingly, since the total driving force acting on the guide pulleys 44a and 44d is 2 WD relative to the L3 direction, the driving force of 2 WD acts on the middle frame 6 that holds the guide pulley 44, but the middle frame 6 does not move because the driving force is blocked in the width direction. Meanwhile, since the total driving force acting on the top board fixing parts 53a and 53d is 2 WU relative to the L3 direction, the top board 5 moves on the middle frame 6 by the driving force of 2 WU in the L3 direction.

FIG. 9 is a view showing an operation in moving the top board 5 and the middle frame 6 in the vertical direction while moving the top board 5 in the horizontal direction. By simultaneously setting the top board and the middle frame by the operating unit 8, the system controlling unit 9 controls the horizontal movement mechanism 4 and set so as to horizontally move the top board 5 and the middle frame 6 onto the supporting part of the image diagnostic apparatus of the MRI apparatus 100 and the bed supporting part 12 in the direction of an L1 and L2, L1 and L3, L4 and L3, or L4 and L2.

By the control of the system controlling unit 9, the horizontal movement mechanism 4 horizontally moves the top board 5 and the middle frame 6 from the position shown in FIG. 3 into the L1 and L2 direction by rotating the motors 41a in the R1 direction while differentially rotating the motor 41b at the rotation speed lower than that of the motor 41a in the R1 or R2 direction, thus setting the top board 5 and the middle frame 6 to the position shown in FIG. 9. In addition, the horizontal movement mechanism 4 horizontally moves and sets the top board 5 and the middle frame 6 by rotating the motors 41b in the R1 direction while differentially rotating the motor 41a at the rotation speed lower than that of the motor 41b in the R1 or R2 direction.

In addition, by rotating the motors 41a in the R2 direction while differentially rotating the motor 41b at the rotation speed lower than that of the motor 41a in the R1 or R2 direction, the top board 5 and the middle frame 6 are horizontally moved in the direction of L4 and L3 to set. Furthermore, by rotating the motors 41b in the R2 direction while differentially rotating the motor 41a at the rotation speed lower than that of the motor 41b in the R1 or R2 direction, the top board 5 and the middle frame 6 are horizontally moved in the direction of L4 and L2 to set.

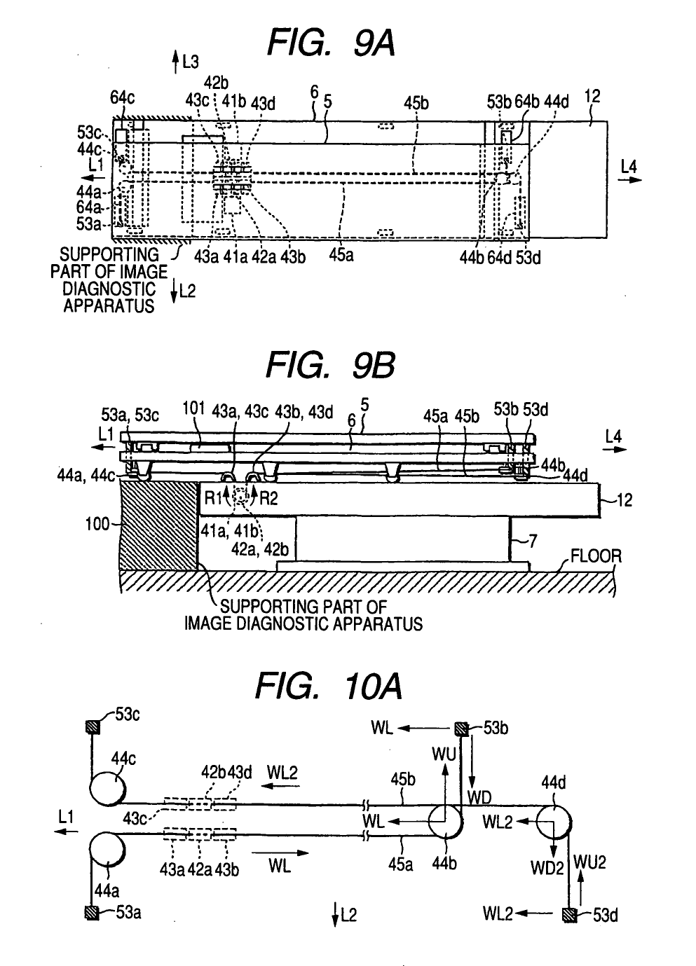

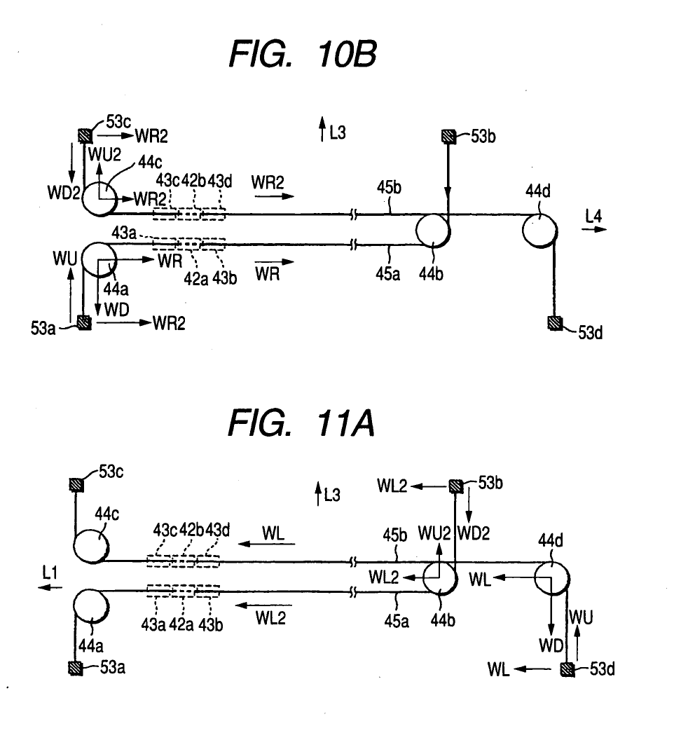

FIG. 10A is a view showing a magnitude and direction of the driving force of the horizontal movement mechanism 4 in moving the top board 5 and the middle frame 6 in the L1 direction while moving the top board 5 in the L2 direction. By rotating the motors 41a in the R1 direction while differentially rotating the motor 41b at the rotation speed lower than that of the motor 41a in the R1 direction, the tension WL indicated as arrows acts on the wire 45a between the idle pulley 43b and the guide pulley 44b through the driving pulley 42a, and the tension WL2 that has a half magnitude of the tension WL and the same direction as the tension WL acts on the wire 45b between the idle pulley 43d and the guide pulley 44d through the driving pulley 42b.

Due to the tension WL acting on the wire 45a, the driving forces WL and WU act on the guide pulley 44b, and the driving forces WL and WD act on the top board fixing part 53b. In addition, due to the tension WL2 acting on the wire 45b, the driving force WL2 and the driving force WD2 that has the same magnitude as the driving force WL2 and is oriented to the top board fixing part 53d act on the guide pulley 44d, and the driving force WL2 and the driving force WU2 that has the same magnitude as the driving force WD2 and is reversely oriented to the driving force WD2 act on the top board fixing part 53d.

Accordingly, since the total driving force acting on the guide pulleys 44b and 44d is 1.5 WL and 0.5 WU relative to the direction of L1 and L3, the middle frame 6 prevents the driving force in the L3 direction (width direction) and moves onto the bed supporting part 12 in the L1 direction by the driving force of 1.5 WL. At the same time, since the total driving force acting on the top board fixing parts 53b and 53d is 1.5 WL and 0.5 WD relative to the direction of L1 and L2, the top board 5 moves together with the middle frame 6 in the L1 direction and moves onto the middle frame 6 by the driving force of 0.5 WD in the L2 direction.

FIG. 10B is a view showing a magnitude and direction of the driving force of the horizontal movement mechanism 4 in moving the top board 5 and the middle frame 6 in the L4 direction while moving the top board 5 in the L3 direction. By rotating the motor 41a in the R2 direction while differentially rotating the motor 41b at the rotation speed lower than that of the motor 41a in the R2 direction, the tension WR acts on the wire 45a between the idle pulley 43a and the guide pulley 44a through the driving pulley 42a, and the tension WR2 that has a half magnitude of the tension WR and the same direction as the tension WR2 acts on the wire 45b between the idle pulley 43c and the guide pulley 44c through the driving pulley 42b.

Due to the tension WR acting on the wire 45a, the driving forces WR and WD act on the guide pulley 44a, and the driving forces WR and WU act on the top board fixing part 53a. In addition, due to the tension WR2 acting on the wire 45b, the driving force WR2 and WU2 act on the guide pulley 44c, and the driving force WR2 and WD2 act on the top board fixing part 53c.

Accordingly, since the total driving force acting on the guide pulleys 44a and 44c is 1.5 WR and 0.5 WD relative to the direction of L4 and L2, the middle frame 6 prevents the driving force in the L2 direction (width direction) and moves the bed supporting part 12 in the L4 direction by the driving force of 1.5 WR. At the same time, since the total driving force acting on the top board fixing parts 53a and 53c is 1.5 WR and 0.5 WU relative to the direction of L4 and L3, the top board 5 moves together with the middle frame 6 in the L4 direction and moves onto the middle frame 6 by the driving force of 0.5 WU in the L3 direction.

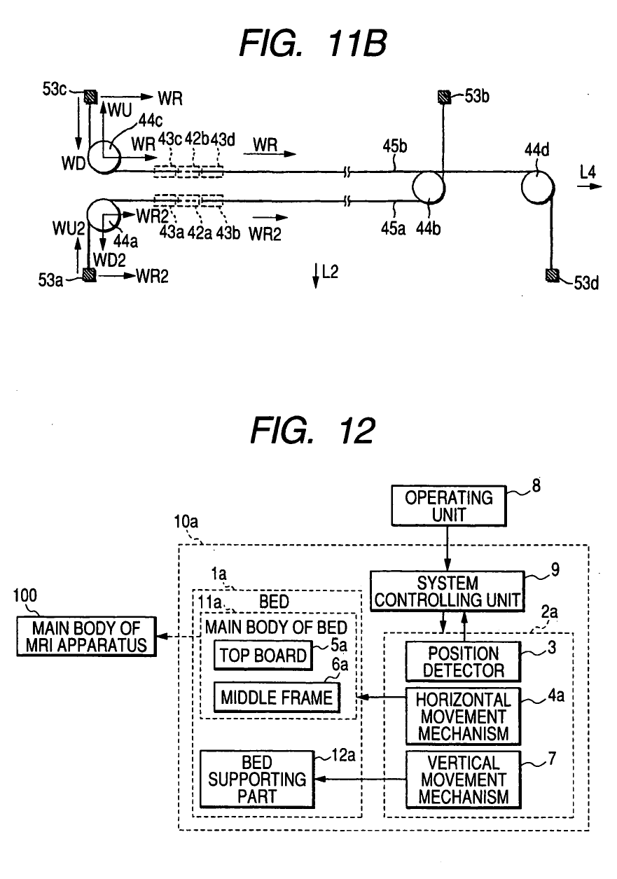

FIG. 11A is a view showing a magnitude and direction of the driving force of the horizontal movement mechanism 4 in moving the top board 5 and the middle frame 6 in the L1 direction while moving the top board 5 in the L3 direction. By rotating the motors 41b in the R1 direction while differentially rotating the motor 41a at the rotation speed lower than that of the motor 41b in the R1 direction, the tension WL acts on the wire 45b between the idle pulley 43d and the guide pulley 44d through the driving pulley 42b, and the tension WL2 acts on the wire 45a between the idle pulley 43b and the guide pulley 44b through the driving pulley 42a.

Due to the tension WL acting on the wire 45b, the driving forces WL and WD act on the guide pulley 44d, and the driving forces WL and WU act on the top board fixing part 53d. In addition, due to the tension WL2 acting on the wire 45a, the driving forces WL2 and WU2 act on the guide pulley 44b, and the driving forces WL2 and WD2 act on the top board fixing part 53b.

Accordingly, since the total driving force acting on the guide pulleys 44d and 44b is 1.5 WL and 0.5 WD relative to the direction of L1 and L2, the middle frame 6 prevents the driving force in the L2 direction and moves onto the bed supporting part 12 in the L1 direction by the driving force of 1.5 WL. At the same time, since the total driving force acting on the top board fixing parts 53d and 53b is 1.5 WL and 0.5 WU relative to the direction of L1 and L3, the top board 5 moves together with the middle frame 6 in the L1 direction and moves onto the middle frame 6 by the driving force of 0.5 WU in the L3 direction.

FIG. 11B is a view showing a magnitude and direction of the driving force of the horizontal movement mechanism 4 in moving the top board 5 and the middle frame 6 in the L4 direction while moving the top board 5 in the L2 direction. By rotating the motor 41b in the R2 direction while differentially rotating the motor 41a at the rotation speed smaller than that of the motor 41b in the R2 direction, the tension WR acts on the wire 45b between the idle pulley 43c and the guide pulley 44c through the driving pulley 42b, and the tension WR2 acts on the wire 45a between the idle pulley 43a and the guide pulley 44a through the driving pulley 42a.

Due to the tension WR acting on the wire 45b, the driving forces WR and WU act on the guide pulley 44c, and the driving forces WR and WD act on the top board fixing part 53c. In addition, due to the tension WR2 acting on the wire 45a, the driving force WR2 and WD2 act on the guide pulley 44a, and the driving force WR2 and WU2 act on the top board fixing part 53a.

Accordingly, since the total driving force acting on the guide pulleys 44c and 44a is 1.5 WR and 0.5 WU relative to the direction of L4 and L3, the middle frame 6 prevents the driving force in the L3 direction and moves onto the bed supporting part 12 in the L4 direction by the driving force of 1.5 WR. At the same time, since the total driving force acting on the top board fixing parts 53c and 53a is 1.5 WR and 0.5 WD relative to the direction of L4 and L2, the top board 5 moves together with the middle frame 6 in the L4 direction and moves onto the middle frame 6 by the driving force of 0.5 WD in the L2 direction.

Next, the procedure for collecting imaging data of the object by using the MRI apparatus will be described. The object is mounted on the top board 5. The operator inputs an instructing signal of the top board movement in the operating unit 8 and moves the middle frame 6 in the longitudinal direction and the top board 5 in the width direction so that the portion of the object to be imaged (for example, head or shoulder) is approximately located at the center of an imaging area provided in the gantry of the main body 100 of the MRI apparatus. Then, the operator conducts the imaging by inputting a command signal for starting the imaging.

When the imaging starts, a radio frequency pulse (RF pulse) is supplied to a RF coil unit 101 from a transmitting unit, and the RF coil unit 101 generates a high frequency magnetic field. During the imaging, the RF coil unit 101 is inserted into a hollow of the gantry together with the object. A RF coil 100 receives the magnetic resonance signal radiated from the object.

The movement in the width direction of the top board 5 and the movement in the longitudinal direction of the middle frame 6 are performed in order or in turn, and are simultaneously performed. That is, it may move in an oblique direction.

In addition, in the case of continuously imaging in an axial direction of the subject, before a main scan is performed, a pilot scan is performed so as to detect a difference in the width direction by inserting an entire body into the gantry. On the basis of the pilot scan, the continuous imaging may be performed by adjusting the difference in the width direction by moving the top board 5 and moving the middle frame 6 in the longitudinal direction.

According to one embodiment of the invention above described, it may move the top board 5 and the middle frame 6 in the longitudinal direction by using one horizontal movement mechanism of a simple structure, and move the only the top board 5 in the width direction at any position in the longitudinal direction, thus setting the position.

In addition, it may be set the position by moving the top board 5 and the middle frame 6 in the longitudinal direction and moving the top board 5 in the width direction.

Furthermore, in the case of the imaging of the MRI apparatus by using the RF coil, it may align the RF coil 101 to the top board 5 by disposing the RF coil 101 at any position on the middle frame and moving the top board 5 on which the object is mounted in the width direction.

As above-described, by using the components that do not require parts with a high precision and reducing the load into the driving system, it may set the position of the top board at a short time without investing an effort or time, or may align the position of the object and the RF coil.

In addition, the RF coil 101 is provided in the middle frame 6, but may be disposed so as to be fixed in the gantry.

Furthermore, since a toothed wire is used as the wires 45a and 45b, it may prevent a sliding with the pulley and conduct the positioning with the precision or high speed. The toothed wire, for example, may be used by winding a braiding on a straight core.

### Example 2

Hereinafter, an example 2 of a bed device according to the invention will be described. The example 2 shown in FIG. 12 is differ out from the example 1 in FIG. 1 in that a top board 5a of a main body 11a of the bed of FIG. 12 is configured so as to be fixed on a bed supporting part 12a and that a horizontal movement mechanism 4a horizontally moves the top board except the main body 11a of the bed in a longitudinal direction.

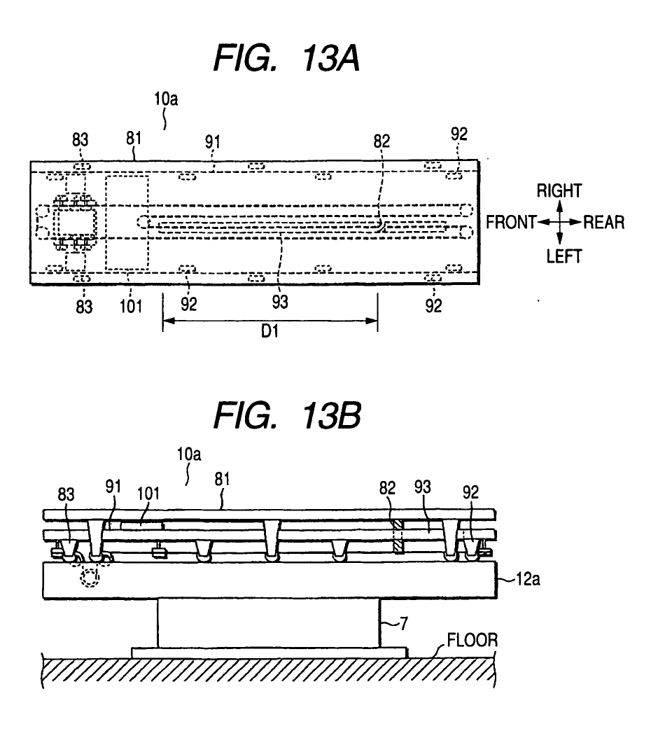

FIGS. 13A and 13B are views showing a structure of a bed 1a of the example 2. FIG. 13A is a top view of a bed device 10a, and FIG. 13B is a side view of the bed device 10a. In addition, the main body 11a of the bed shown in FIG. 13 is set for a home position.

The main body 11a of the bed 1a includes the top board 5a for mounting an object and a middle frame 6a for horizontally moving the top board 5a.

The top board 5a is provided with a rectangular main body 81 of the top board on which the object is mounted, a top board fixing part 82 that transmits a driving force for moving the top board 5 from front to back into the main body 81 of the top board, and a plurality of roller 83 that support the main body 81 of the top board on the bed supporting part 12a.

The object is mounted on the upper surface of the main body 81 of the top board, and the upper end of the top board fixing part 82 is fixed in the vicinity of the center in a width direction at a rear more than a center in a longitudinal direction of a lower surface. The lower end of the top board fixing part 82 is held by a part of a wire of a horizontal movement mechanism 4a.

The plurality of rollers 83 is disposed at a predetermined distance across both long side ends of the lower surface of the main body 81 of the top board. The top board 5a may smoothly move on the bed held part 12a in the longitudinal direction through the rollers 83.

The middle frame 6a is disposed between the top board 5a and the bed supporting part 12a and is provided with a main body 91 of the middle frame, a plurality of rollers 92 for supporting the main body 91 of the middle frame, and a slotted hole 93 provided in the main body 91 of the middle frame.

The main body 91 of the middle frame is formed to have a rectangular shape having a long side that is approximately equal to the length of the long side of the top board 5a and a short side that is shorter than the distance between the plurality of rollers 83 that are disposed at both side in the width direction of the top board 5a.

The plurality of rollers 92 is disposed at a predetermined distance across both long side ends of the lower surface of the main body 91 of the middle frame. The middle frame 6a may smoothly move on the bed supporting part 12a in the longitudinal direction through the rollers 92.

The slotted hole 93 is located on the on the back of the main body of the middle frame 91 in the longitudinal direction slightly shifted to the left from the center in the width direction, and one end of the slotted hole 93 is formed at the front position of a distance D1 from the top board fixing part 82 of the top board 5a and in a position anterior to the center in the longitudinal direction of the main body 91 of the middle frame, while the other end thereof is formed in the vicinity of the rear end of the main body 91 of the middle frame. In addition, the top board fixing part 83 of the top board 5a is penetrated through the slotted hole 93.

Furthermore, in the case of imaging the object by using an MRI apparatus 100, a RF coil 101 is disposed at any position on the middle frame 6a.

The bed supporting part 12a is disposed on a lower side of the middle frame 6a and forms a rectangular upper surface that is approximately similar to the shape of the top board 5a. In addition, the bed supporting part 12a supports the top board 5a and the middle frame 6a so as to horizontally move in the longitudinal direction.

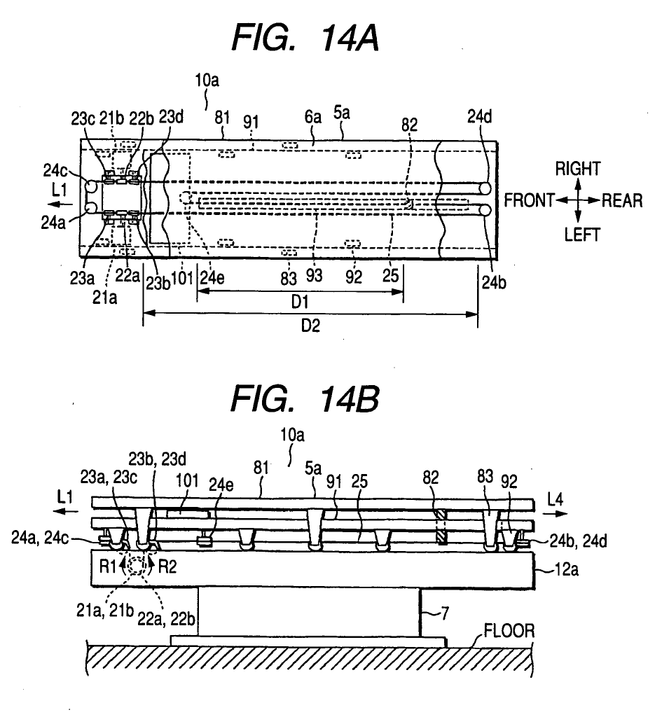

FIGS. 14A and 14B are views showing structures of a horizontal movement mechanism 4a of the example 2. FIG. 14A is a configuration view of the horizontal movement mechanism 4a as viewed from the upper side by cutting the front and rear of the bed device 10a, and FIG. 14B is a left side view of the horizontal movement mechanism 4a.

The horizontal movement mechanism 4a is provided with two motors 21 (21a and 21b) as a power source for driving the main body 11a of the bed, two driving pulleys 22 (22a and 22b) that transmit a driving force of the motors 21 into a wire 25, four idle pulleys 23 (23a to 23d) that convert the directions of the wire 25, and five guide pulleys 24 (24a to 24e) that transmit the driving force from the wire 25 into the middle frame 6a. The driving force from the wire 25 is also transmitted into the top board 5a through the top board fixing parts 82.

The motor 21 is composed of the motors 21a and 21b provided in the vicinity of the front end inside the bed supporting part 12a. The rotation shafts of the motors 21a and 21b face each other at a position of line symmetry with respect to a center line in the width direction of the bed supporting part 12a, and the motors 21a and 21b are disposed and fixed so as to be parallel to the short side of the bed supporting part 12a.

The driving pulley 22 is a toothed wheel that is engaged with the wire 25. In addition, the driving pulleys 22 are provided with the driving pulleys 22a and 22b having tooth of the same number and fixed to the rotation shaft of the motors 21a and 21b.

The idle pulley 23 is composed of the idle pulleys 23a and 23b disposed at the front and rear of the upper side of the driving pulley 22a and the idle pulleys 23c and 23d disposed at the front and rear of the upper side of the driving pulley 22b. Furthermore, the rotation shafts of the idle pulleys 23a to 23d are disposed so as to be parallel and horizontal to the short side of the bed supporting part 12a, and one end of each rotation shaft is fixed to upper side of the upper surface of the bed supporting part 12a.

The guide pulley 24 is composed of the guide pulleys 24a to 24e having the same diameter in which the end of each rotation shaft is vertically fixed to the lower surface of the main body 91 of the middle frame, and are disposed between the main body 91 of the middle frame and the bed supporting part 12a. In addition, the guide pulley 24a is disposed in the vicinity of the front end of the main body 91 of the middle frame and on the left side of the center in the width direction, and the guide pulley 24b is disposed in the vicinity of the end of the main body 91 of the middle frame of the rear of the guide pulley 24a and at the distance D2 of the rear of the idle pulley 23b.

In addition, the guide pulleys 24c and 24d are disposed at the position of the line symmetry with respect to the center line in the width direction of the main body 91 of the middle frame relative to the guide pulleys 24a and 24b by the distance of one guide pulley from the guide pulleys 24a and 24b.

In addition, the guide pulley 24e is disposed at the center in the width direction of the main body 91 of the middle frame and slightly ahead of the one end of the slotted hole 93.

The annular wire 25 is formed so as to engage with the driving pulleys 22a and 22b, and wound in order of the driving pulley 22a, the idle pulley 23b, the guide pulley 24e, the guide pulley 24d, the idle pulley 23d, the driving pulley 22b, the idle pulley 23c, the guide pulley 24c, the guide pulley 24a, and the idle pulley 23a.

The horizontal movement mechanism 4a configured in this manner may horizontally move the main body 11a of the bed in the longitudinal direction. In addition, the horizontal movement mechanism 4a may horizontally move the only top board 5a in the longitudinal direction at any position where the main body 11a of the bed is moved.

Next, the operation of the main body 11a of the bed of the example 2 and the horizontal movement mechanism 4a will be described.

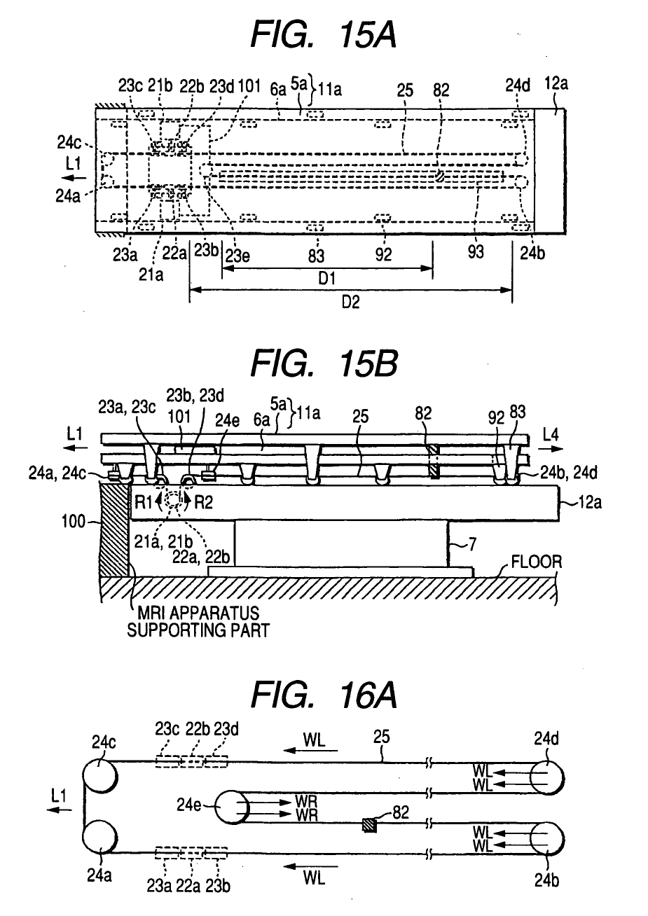

FIGS. 15A and 15B are views showing a moving operation of a main body 11a of the bed. The operating unit 8 sets the position of the main body of the bed, and the system controlling unit 9 controls the horizontal movement mechanism 4a and sets so as to horizontally move the main body 11a of the bed in the direction of the L1 or L4.

By the control of the system controlling unit 9, the horizontal movement mechanism 4a horizontally moves the main body 11a of the bed from a home position shown in FIG. 14 in the L1 direction by rotating both the motors 21a and 21b at the same speed in the direction of the arrow R1 so as to set to the position shown in FIGS. 15A and 15B. In addition, the horizontal movement mechanism 4a horizontally moves the main body 11a of the bed into the L4 direction by rotating both the motors 21a and 21b at the same speed in the direction of the arrow R2.

In addition, the main body 11a of the bed is moved from the home position into the distance D2 in the L1 direction.

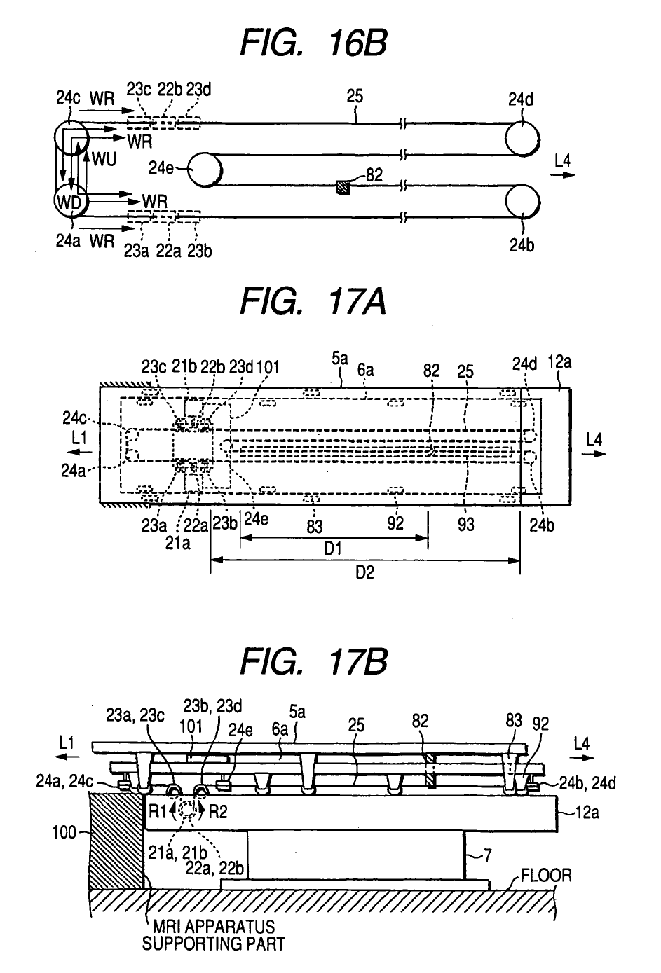

FIG. 16A is a view showing the magnitude and direction of the driving force of the horizontal movement mechanism 4a in moving the main body 11a of the bed in the L1 direction. By rotating both the motors 21a and 21b at the same speed in the direction of the R1, a tension WL acts on the wire 25 between the idle pulley 23b and the guide pulley 24b through the driving pulley 22a and on the wire 25 between the idle pulley 23d and the guide pulley 24d through the driving pulley 22b.

Due to the each tension WL acting on the wire 25, the driving force 2 WL acts on the guide pulleys 24b and 24d, respectively, and the driving force 2 WR acts on the guide pulley 24e. In addition, since the total driving force acting on the guide pulleys 24b, 24d, and 24e is 2 WL relative to the L1 direction, the middle frame 6a that holds the respective guide pulleys 24 moves onto the bed supporting part 12a in the L1 direction by the driving force of 2 WL.

Meanwhile, two tensions WL acting on between the guide pulley 24a and the guide pulley 24b, and between the guide pulley 24c and the guide pulley 24d act in the direction opposite to each other with respect to the wire 25, thereby canceling the two tensions. In addition, the wire 25 does not move through the guide pulleys 24a to 24e, the top board fixing part 82 that is fixed to the wire 25 does not move.

Accordingly, the top board 5a holding the top board fixing part 82 does not move alone, and the top board 5a move onto the bed fixing part 12a together with the middle frame 6a.

FIG. 16B is a view showing the size and direction of the driving force of the horizontal movement mechanism 4a in moving the main body 11a of the bed into the L4 direction. By rotating both the motors 21a and 21b at the same speed in the direction of the R2, the tension WR acts on the wire 25 between the idle pulley 23a and the guide pulley 24a through the driving pulley 22a and on the wire 25 between the idle pulley 23c and the guide pulley 24c through the driving pulley 22b.

Due to the tension WR from the driving pulley 22a acting on the wire 25, the driving forces WR and WU act on the guide pulley 24a, and the driving forces WR and WD act on the guide pulley 24c via the guide pulley 24a. In addition, due to the tension WR from the driving pulley 22b acting on the wire 25, the driving forces WR and WD act on the guide pulley 24c, and the driving forces WR and WU act on the guide pulley 24a via the guide pulley 24c.

Accordingly, since the total driving force acting on the guide pulleys 24a and 24c is 2 WR relative to the L4 direction, the middle frame 6a moves onto the bed supporting part 12a in the L4 direction by the driving force 2 WR.

Meanwhile, two tensions WR acting on between the guide pulley 24a and the guide pulley 24b, and between the guide pulley 24c and the guide pulley 24d act in the direction opposite to each other with respect to the wire 25, thereby canceling the two tensions. In addition, the wire 25 does not move through the guide pulleys 24a to 24e.

Accordingly, the top board 5a does not move alone, and the top board 5a move onto the bed fixing part 12a together with the middle frame 6a.

FIGS. 17A and 17B are views showing a moving operation of an only top board 5a. The operating unit 8 sets the position of the top board, and the system controlling unit 9 controls the horizontal movement mechanism 4a and sets so as to horizontally move the top board 5a onto a supporting part of the image diagnostic apparatus of the MRI apparatus 100 and the bed supporting part 12a in the direction of L1 or L4.

By the control of the system controlling unit 9, the horizontal movement mechanism 4a horizontally moves the only top board 5a from any position shown in FIGS. 15A and 15B in the L1 direction by simultaneously rotating the motors 21a in the R1 direction and the motor 21b in the R1 direction at the same speed. In addition, the horizontal movement mechanism 4a horizontally moves the top board 5a in the L4 direction by simultaneously rotating the motor 21a in the R1 direction and the motor 21b in the R2 direction at the same speed.

In addition, in the case of moving the top board 5a in the L1 direction, the top board may move from the position that is combined with the middle frame 6a to the distance D1. Accordingly, it may set to the position of the longest distance (D1+D2) by moving the main body 11a of the bed from the home position into the distance D2 in the L1 direction and moving the top board 5a to the distance D1 in the L1 direction.

Furthermore, in the case of imaging the object by using the MRI apparatus 100, the top board 5a on which the object is mounted moves in the direction of L1 or L4, resulting in being aligned with the RF coil 101 disposed on the middle frame 6a.

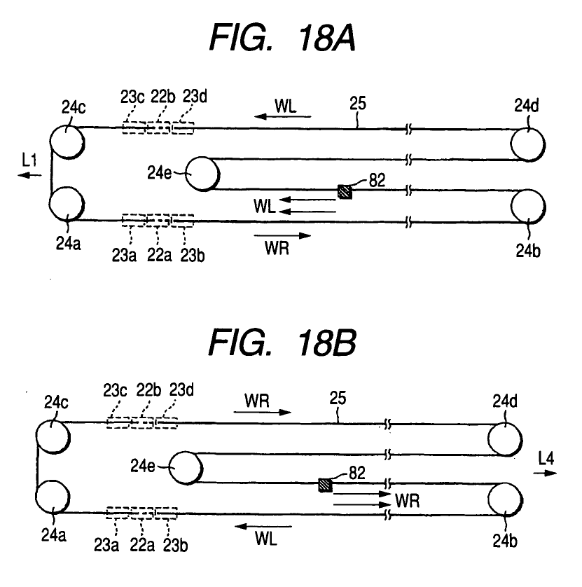

FIG. 18A is a view showing the size and direction of the driving force of the horizontal movement mechanism 4a in moving the top board 5a into the L1 direction. By simultaneously rotating the motors 21a and 21b at the same speed in the direction of the R2 and R1, respectively, the tension WL acts on the wire 25 between the idle pulley 23a and the guide pulley 24a through the driving pulley 22a and acts on the wire 25 between the idle pulley 23d and the guide pulley 24d through the driving pulley 22b.

Since the tensions WR and WL acting on the wire 25 act in the same direction and at the same magnitude, the driving forces of the guide pulleys 24a to 24e are canceled, and the guide pulleys 24a to 24e are rotated so that the wire 25 of the position of the top board fixing part 82 moves in the L1 direction. Accordingly, the only the top board 5a moves onto the bed supporting part 12a in the L1 direction.

FIG. 18B is a view showing the size and direction of the driving force of the horizontal movement mechanism 4a in moving the top board 5a into the L4 direction. By simultaneously rotating the motors 21b and 21a at the same speed in the direction of the R2 and R1, respectively, the driving forces WL and WR act on the wire 25 between the idle pulley 23b and the guide pulley 24b through the driving pulley 22a and acts on the wire 25 between the idle pulley 23c and the guide pulley 24c through the driving pulley 22b.

Since the tensions WR and WL acting on the wire 25 act in the same direction and the same magnitude, the driving forces of the guide pulleys 24a to 24e are canceled, and the guide pulleys 24a to 24e are rotated so that the wire 25 of the position of the top board fixing part 82 moves in the L4 direction. Accordingly, the only the top board 5a moves onto the bed supporting part 12a in the L4 direction.

Next, the procedure for collecting imaging data of the object by using the MRI apparatus will be described. The object is mounted on the top board 5. The operator inputs an instructing signal of the top board movement in the operating unit 8 and moves the top board 5a and the middle frame 6a in the longitudinal direction so that the portion of the object to be imaged (for example, head or shoulder) is approximately located at the center of an imaging area provided in the gantry of the main body 100 of the MRI apparatus. Then, the operator conducts the imaging by inputting a command signal for starting the imaging.

According to the example 2 of the invention above described, it may move the top board 5a and the middle frame 6a in the longitudinal direction by using the horizontal movement mechanism of one system having a simple structure, and move the only the top board 5a in the longitudinal direction, thus setting the position.

Furthermore, in the case of the imaging of the MRI apparatus by using the RF coil, it may align the RF coil 101 to the top board 5a by disposing the RF coil 101 at any position on the middle frame 6a and moving the top board 5a on which the object is mounted in the longitudinal direction.

As above-described, by using the components that have no need of parts with a high precision and reducing the load into the driving system, it may set the position of the top board at a short time without investing an effort or labor, or may align the position of the object and the RF coil.

In addition, since the driving system of the top board 5a and the middle frame 6a may be carried out by one driving system, the size in the longitudinal direction of the middle frame 6a may be shortened. Accordingly, the vertical movement mechanism 7 is miniaturized, it may compact the entire bed device 10 and reduce an installation area.

Furthermore, the invention is not limited to the examples 1 and 2. For example, in order to transmit the driving force from one motor into two driving pulleys, it may move the top board and the middle frame by providing a gear for rotating the two driving pulley having the same size in the same direction, a reversal gear for rotating the two driving pulley having the same size in the reverse direction to each other, and a clutch for switching into the gear and the reversal gear.

According to the present invention, it may easily set the position of the top board by horizontally moving a driving top board and a middle frame of a same system in the longitudinal direction and horizontally moving the top board in the width direction at any moved position. In addition, it may easily set the position of the top board by horizontally moving the top board and the middle frame in the longitudinal direction and horizontally moving the top board in the longitudinal direction from any moved position.

1. A bed device comprising:
a top board on which an object is disposed;
a middle frame that is disposed on the lower side of the top board and supports the top board;
a bed supporting part that is disposed on the lower side of the middle frame and supports the middle frame; and
movement mechanisms that move both the top board and the middle frame in a longitudinal direction and separately move the top board from the middle frame in a width direction.

2. The bed device according to claim 1,
wherein the movement mechanism includes first and second driving mechanisms that are disposed on the bed supporting part so as to drive the top board and the middle frame, and first and second transmittance mechanisms that transmit driving forces from the first and second driving mechanisms to the top board and the middle frame.

3. The bed device according to claim 2,
wherein the first and second driving mechanisms move the top board and the middle frame in the longitudinal direction when supplying the driving forces in the longitudinal direction at the same magnitude and in the same direction to the first and second transmittance mechanisms.

4. The bed device according to claim 2,
wherein the first and second driving mechanisms move the top board and the middle frame in the longitudinal direction and move the top board in a width direction when supplying the driving forces in the longitudinal direction at the magnitude different from each other and the same direction to the first and second transmittance mechanisms.

5. The bed device according to claim 2,
wherein the first and second driving mechanisms supply the driving forces to the first and second transmittance mechanisms in an L1 direction, that is, longitudinal direction,
the first transmittance mechanism transmits the driving force from the first driving mechanism to the top board in the L1 direction and the L2 direction, and transmits the driving force to the middle frame in the L1 direction and an L3 direction opposite to the L2 direction that is the width direction of the top board, and
the second transmittance mechanism transmits the driving force from the second driving mechanism to the top board in the L1 direction and the L3 direction, and
transmits to the middle frame in the L1 direction and the L2 direction.

6. The bed device according to claim 2,
wherein the first and second transmittance mechanisms include;
first and second wires through which the driving forces from the first and second driving mechanisms are supplied;
first and second pulleys that transmit the driving forces from the first and second wires to the middle frame; and
first and second top board fixing parts that transmit the driving forces from the first and second wires to the top board through the first and second pulleys.

7. The bed device according to claim 2,
wherein the first and second driving mechanisms supply the driving forces having the same magnitude and the direction opposite to the first and second transmittance mechanisms in the longitudinal direction opposite to each other so as to move the top board in the width direction.

8. The bed device according to claim 2,
wherein the first and second driving mechanisms move the driving forces having a magnitude different from each other and a direction opposite to each other to the first and second transmittance mechanisms in the longitudinal direction of the top board and the middle frame so as to move the top board and the middle frame in the longitudinal direction and move the top board in the width direction.

9. The bed device according to claim 2,
wherein the first driving mechanism supplies the driving force to the first transmittance mechanism in the L11 direction with respect that is the longitudinal direction,
the first transmittance mechanism transmits the driving force from the first driving mechanism to the top board in the L1 direction and the L2 direction, and transmits the driving force to the middle frame in the L1 direction and the L3 direction opposite to the L2 direction that is the width direction of the top board,
the second driving mechanism supplies the driving force to the second transmittance mechanism in the L4 direction opposite to the L1 direction, and
the second transmittance mechanism transmits the driving force from the second driving mechanism to the top board in the L4 direction and the L3 direction, and transmits to the middle frame in the L4 direction and the L2 direction.

10. A bed device comprising:
a top board on which an object is disposed;
a middle frame that is disposed on the lower side of the top board;
a bed supporting part that supports the top board and the middle frame;
a first driving mechanism that supplies a driving force for moving the top board and the middle frame;
a second driving mechanism that supplies a driving force for moving the top board and the middle frame; and
movement mechanisms that transmit driving forces having a same magnitude and a same direction from the first and second driving mechanisms so as to move the top board and the middle frame in a longitudinal direction and transmit driving forces having a same magnitude and a direction different from each other from the first and second driving mechanisms so as to move the only top board in a longitudinal direction.

11. The bed device according to claim 10,
wherein the transmittance mechanisms include wires through which the driving forces from the first and second driving mechanisms are supplied, first to fifth pulleys that transmit the driving forces from the wires to the middle frame, and top board fixing parts that transmit the driving forces from the wires to the top board,
the first and second driving mechanisms supply the driving forces having the same magnitude to the wires in a L1 direction or a L4 direction opposite to the L1 direction, and
the wires are used to transmit the driving forces in the L1 direction or the L4 direction from the first and second driving mechanisms to the middle frame through the first to fifth pulleys on which the wires are wound, and used to transmit the driving forces to the top board through the top board fixing parts.

12. The bed device according to claim 11,
wherein the transmittance mechanisms transmit the driving force in the L1 direction from the first driving mechanism to the first pulley through the wires, transmit the driving force in the L4 direction to the second pulley via the first pulley, transmit the driving force in the L1 direction to the third pulley via the first and second pulleys, transmit the driving force in the L1 direction from the second driving mechanism to the third pulley, transmit the driving force in the L4 direction to the second pulley via the third pulley, and transmit the driving force in the L1 direction to the first pulley via the third and second pulleys, so as to move the top board and the middle frame in the L1 direction.

13. The bed device according to claim 1
wherein the transmittance mechanisms transmit the driving force supplied in the L4 direction from the first driving mechanism to the fifth pulley through the wires in the L4 direction and an L3 direction that is a width direction of the top board and the middle frame and to the fourth pulley in the L4 direction and a L2 direction opposite to the L3 direction via the fifth pulley, and transmit the driving force supplied in the L4 direction from the second driving mechanism to the fourth pulley in the L4 and L2 directions and to the fifth pulley in the L4 and L3 directions via the fourth pulley, so as to move the top board and the middle frame in the L4 direction.

14. The bed device according to claim 11,
wherein the transmittance mechanisms transmit the driving force supplied in the L1 or L4 direction from the first driving mechanism to the first to fifth pulleys through the wires, and transmit the driving force supplied in the L4 direction or L1 direction from the second driving mechanism to the first to fifth pulleys so as to move the top board in one direction of the L1 and L4 directions.

15. A bed device comprising:
a top board on which an object is disposed;
a middle frame that is disposed on a lower side of the top board and supports the top board;
a bed supporting part that is disposed on a lower side of the middle frame and supports the middle frame;
driving mechanisms that are provided in the bed supporting part and generate driving forces for moving the top board and the middle frame; and
transmittance mechanisms that transmit the driving forces from the driving mechanisms to the top board and the middle frame.

16. A bed device comprising:
a top board on which an object is disposed;
a middle frame that slidably supports the top board in a width direction perpendicular to a longitudinal direction thereof;
a bed supporting part that slidably supports the middle frame in the longitudinal direction;
first and second driving mechanisms that are provided in the bed supporting part;
first and second wires through which the forces in the longitudinal direction from the second driving mechanisms are supplied;
first and second pulleys that are provided in the middle frame and transmit the driving forces from the first and second wires to the middle frame; and
first and second top board fixing parts that are provided in the top board and transform the driving forces through the first and second wires in the width direction by the first and second pulleys so as to transmit into the top board.

17. A bed device comprising:
a top board on which an object is disposed;
a middle frame that slidably supports the top board in a width direction perpendicular to a longitudinal direction thereof;
a bed supporting part that slidably supports the driving first and middle frame in the longitudinal direction; and
movement mechanisms that move the middle frame in the longitudinal direction and move the top board in the width direction.

18. A bed device comprising:
a top board on which an object is disposed;
a middle frame that slidably supports the top board in a width direction perpendicular to a longitudinal direction thereof;
a bed supporting part that slidably supports the middle frame in the longitudinal direction;
a first driving motor that moves the middle frame in the longitudinal direction; and
a second motor that moves the top board in the width direction.

19. A bed device comprising:
a top board on which an object is disposed;
a middle frame that slidably supports the top board in a width direction perpendicular to a longitudinal direction thereof;
a bed supporting part that slidably supports the middle frame in the longitudinal direction; and
movement mechanisms that move both the top board and the middle frame in the longitudinal direction and move the top board of the top board and the middle frame in the width direction.

20. The bed device according to claim 1, further comprising:
a first driving mechanism that drives the top board;
a second driving mechanism that drives the middle frame;
a first transmittance mechanism that transmits the driving force of the first driving mechanism to the top board; and
a second transmittance mechanism that transmits the driving force from the second driving mechanism to the middle frame,
wherein the first driving mechanism and the second driving mechanism are provided on the lower side of the middle frame.

21. An MRI apparatus comprising:
a bed device including a top board on which an object is disposed, a middle frame that is disposed on the lower side of the top board and supports the top board, a bed supporting part that is disposed on the lower side of the middle frame and supports the middle frame, a driving mechanism that moves the top board and the middle frame together in a longitudinal direction and moves the top board in a width direction separately from the middle frame, and
an MRI apparatus main body that conducts an MRI imaging by generating a magnetic field with respect to the object.

22. An MRI apparatus comprising:
a bed device having a top board on which an object is disposed;
a middle frame that is disposed on the lower side of the top board;
a bed supporting part that supports the top board and the middle frame;
a first driving mechanism that supplies a driving force for moving the top board and the middle frame;
a second driving mechanism that supplies a driving force for moving the top board and the middle frame; and
transmittance mechanisms that transmit driving forces having same magnitudes and same directions from the first and second driving mechanisms so as to move the top board and the middle frame in a longitudinal direction and transmit driving forces having same magnitudes and directions opposite to each other from the first and second driving mechanisms so as to move the only top board in a longitudinal direction; and
a main body of the MRI apparatus that conducts an MRI imaging by generating a magnetic field with respect to the object.

23. An MRI apparatus comprising:
a bed device having a top board on which an object is disposed;
a middle frame that is disposed on the lower side of the top board and supports the top board;
a bed supporting part that is disposed on the lower side of the middle frame and supports the middle frame;
driving mechanisms that are provided in the bed supporting part and generate driving forces for moving the top board and the middle frame; and transmittance mechanisms that transmit the driving forces from the driving mechanisms into top board and the middle frame; and
a main body of the MRI apparatus that conducts an MRI imaging by generating a magnetic field with respect to the object.

24. An MRI apparatus comprising:
a bed device having a top board on which an object is disposed;
a middle frame that slidably supports the top board in a width direction perpendicular to a longitudinal direction thereof;
a bed supporting part that slidably supports the middle frame in the longitudinal direction;
first and second driving mechanisms that are provided in the bed supporting part;
first and second wires that are supplied with the driving forces in the longitudinal direction from the first and second driving mechanisms;
first and second pulleys that are provided in the middle frame and transmit the driving forces from the first and second wires into the middle frame; and first and second top board fixing parts that are provided in the top board and transform the driving forces from the first and second wires in the width direction by the first and second pulleys so as to transmit into the top board; and
a main body of the MRI apparatus that conducts an MRI imaging by generating a magnetic field with respect to the object.

25. An MRI apparatus comprising:
a bed device having a top board on which an object is disposed, a middle frame that slidably supports the top board in a width direction perpendicular to a longitudinal direction thereof, a bed supporting part that slidably supports the middle frame in the longitudinal direction, and
movement mechanisms that move the middle frame in the longitudinal direction and move the top board in the width direction; and
a main body of the MRI apparatus that conducts an MRI imaging by generating a magnetic field with respect to the object.

26. An MRI apparatus comprising:
a bed device having a top board on which an object is disposed, a middle frame that slidably supports the top board in a width direction perpendicular to a longitudinal direction thereof, a bed supporting part that slidably supports the middle frame in the longitudinal direction, movement mechanisms that have a first driving mode which moves the middle frame in the longitudinal direction, and a second mode which moves the top board in the width direction; and
a main body of the MRI apparatus that conducts an MRI imaging by generating a magnetic field with respect to the object.

27. An MRI apparatus comprising:
a bed device having a top board on which an object is disposed, a middle frame that slidably supports the top board in a width direction perpendicular to a longitudinal direction thereof, a bed supporting part that slidably supports the middle frame in the longitudinal direction, and movement mechanisms that move both the top board and the middle frame in the longitudinal direction and move the top board of the top board and the middle frame in the width direction; and
a main body of the MRI apparatus that conducts an MRI imaging by generating a magnetic field with respect to the object.

28. An MRI apparatus comprising:
a bed device having a top board on which an object is disposed;
a gantry that has an opening part in which the object is inserted and generates a magnetic field with respect to a subject portion of the object in an imaging space; and
movement mechanisms that are provided in the bed device and move the top board in an oblique direction with respect to a longitudinal direction thereof when seen the top board from an upper side thereof.
